(19) United States
(12) Patent Application Publication
(10) Pub. No.: US 2004/0019647 A1
(43) Pub. Date: Jan. 29, 2004

(54) Information notification method and system

(76) Inventors: Yun-Chi Lee, Taipei (TW); Wen-Yi Chang, Taipei (TW); Yueh-Chiu Lin, Taipei (TW)

Correspondence Address: BIRCH STEWART KOLASCH & BIRCH, PO BOX 747, FALLS CHURCH, VA, 22040-0747, US

(21) Appl. No.: 10/402,993

(22) Filed: Apr. 1, 2003

(30) Foreign Application Priority Data
Jul. 26, 2002 (TW) 091116692

(51) Int. Cl. G06F 15/16

(52) U.S. Cl. 709/206

(57) ABSTRACT

An information notification method and system is provided for automatically transmitting notification messages to a receiving organization at an information reception device. A fundamental database is established for storing basic information of the receiving organization, each record of the basic information corresponding to at least one item of contact information. The information notification system determines if a notification message is received; if yes, the system reads a name of the receiving organization from the notification message and finds corresponding contact information from the fundamental database. Then, according to the found contact information, the system sends the notification message to the information reception device to allow the receiving organization to obtain the notification message.

### FIELD OF THE INVENTION

The present invention relates to information notification methods and systems, and more particularly, to an information notification method and system for automatically sending out messages according to contact information of an information receiving organization.

### BACKGROUND OF THE INVENTION

In general, business information is exchanged by transferring the detail reports between each enterprise and its cooperative company via e-mail or fax to save time. However, it is inevitable to require the use of human resources in the transfer process of detail reports, that is, to enter the receiver's e-mail address or the receiver's fax number by an employee. Such an operation procedure is very time-consuming and inefficient. Therefore, the present invention is intended to solve the problem of how to provide an information notification method and system so that the enterprise may conserve human resources and time for transferring the detail reports.

### SUMMARY OF THE INVENTION

A primary objective of the present invention is to provide an information notification method and system so that the enterprise may reduce the costs of human resources and time for transferring the detail reports.

To achieve the above and other objectives, the present invention provides an information notification method and system that may automatically transfer a notification message from the information sending organization to the receiving organization via a network system. A fundamental database for storing the basic information of each of the receiving organization is pre-established in the information notification system and the basic information of each of the receiving organization corresponds to at least one contact information. The information notification system may decide whether a notification message is received, if not, the information notification system will then continue the decision process. If a notification message is received, then read the data of the name of receiving organization provided by the notification message. A contact information is searched from the fundamental database of the information notification system according to the data of the name of receiving organization read. The notification message is then sent to the information-receiving device of the receiving organization based on the contact information found so that the receiving organization may receive the notification message.

### BRIEF DESCRIPTION OF THE DRAWINGS

The present invention can be more fully understood by reading the following detailed description of the preferred embodiments, with reference made to the accompanying drawings, wherein:

FIG. 1 is a system block diagram showing basic structure an information notification system according to the invention;

FIG. 2 is a schematic diagram of a web page provided for a user to enter contact information through the use of the information notification system according to the invention;

FIG. 3 is a schematic diagram showing basic information and contact information of receiving organizations stored in a fundamental database of the information notification system according to the invention;

FIG. 4 is a schematic diagram of a detail report received by the information notification system according to the invention; and

FIG. 5 is a flow diagram showing procedural steps for performing an information notification method according to the invention.

### DETAILED DESCRIPTIONS OF THE PREFERED EMBODIMENTS

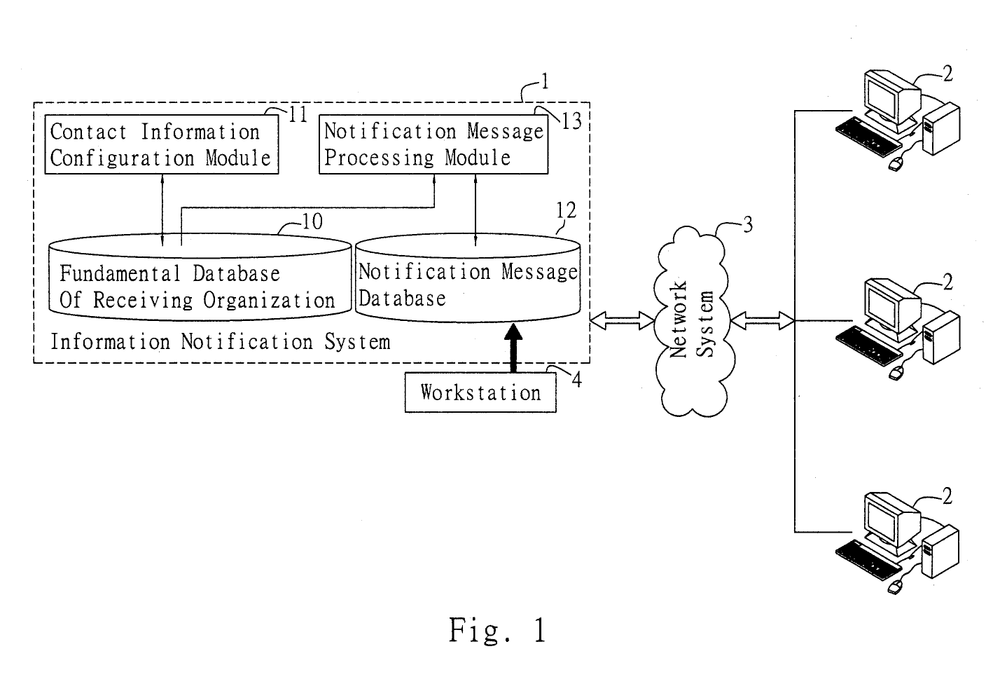

In FIG. 1, the basic structure block diagram of one embodiment of the present invention of an information notification system is illustrated. As shown in the figure, in this particular embodiment, the information notification system (within area of the dotted line) is constructed on a website server (not shown). Based on the name of the receiving organization generated on an information processing workstation 4 (e.g. the website server constructed by the product manufacturer, importer company, exporter company, or customs services company), the present invention of an information notification system 1 may automatically send a detail report (e.g. shipping bill, import detail report, export detail report, or receipt detail) to the computer device 2 (e.g. personal digital assistant, desktop computer, notebook computer, palm computer, cellular phone or e-mail server) of the receiving organization via a network system 3 (e.g. the Internet). The information notification system 1 includes at least a fundamental database 10 of the basic information of receiving organizations, a contact information configuration module 11, a notification message database 12, and a notification message processing module 13. It is noted that the present invention of information notification system 1 also includes other functional modules, the discussion herein only concerns the related parts.

The fundamental database 10 of the basic information of receiving organizations stores the basic information of the receiving organizations, for example, the order client, the exporter company, the importer company, wherein, the basic information includes, for example, the name of the receiving organization and its unified serial number.

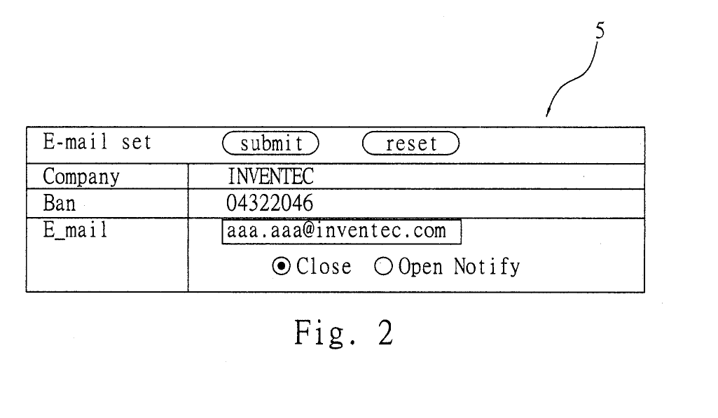

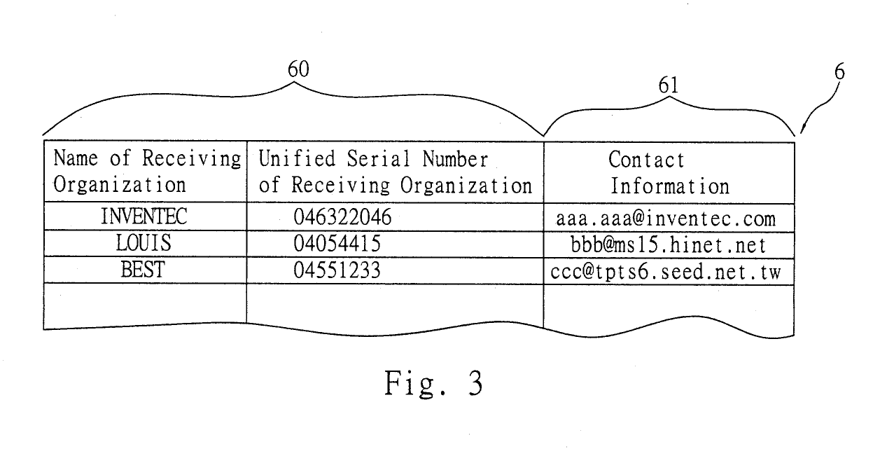

The contact information configuration module 11 provides the data manager with a contact information input form 5 (as shown in FIG. 2) via the network system 3. If the contact information is not filled into the basic information of the receiving organization stored in the fundamental database 10, the contact information configuration module 11 then provides the data manager with a contact information input form 5 to configure the contact information of the receiving organization. In this particular embodiment, the contact information input form 5 is the form for inputting an e-mail address. The “INVENTEC” and the “04322046” shown on the contact information input form 5 are the name of the contact organization and the unified serial number of the company of the contact organization, respectively. After the data manager has finished the configuration, the contact information configuration module 11 retrieves, from the fundamental database 10, a data item of the contact information of the receiving organization corresponding to the data of “INVENTEC” and “04322046” to append the contact information (i.e. “aaa.aaa@inventec.com”, as shown in FIG. 2) inputted by the contact information input form 5 to the retrieved basic information of the receiving organization. As the data structure shown in FIG. 3, wherein label 60 indicates the part of the basic information of the contact organization. In addition to the name of receiving organization and the unified serial number of the receiving organization, as shown in the figure, the part of the basic information may also include other data fields, for example, the address and phone number of the receiving organization. However, only the related parts are shown in this particular embodiment. The label 61 indicates the part of the contact information of the contact organization, wherein, in addition to the e-mail address shown in the figure, the part of contact information may also include the fax and/or phone number.

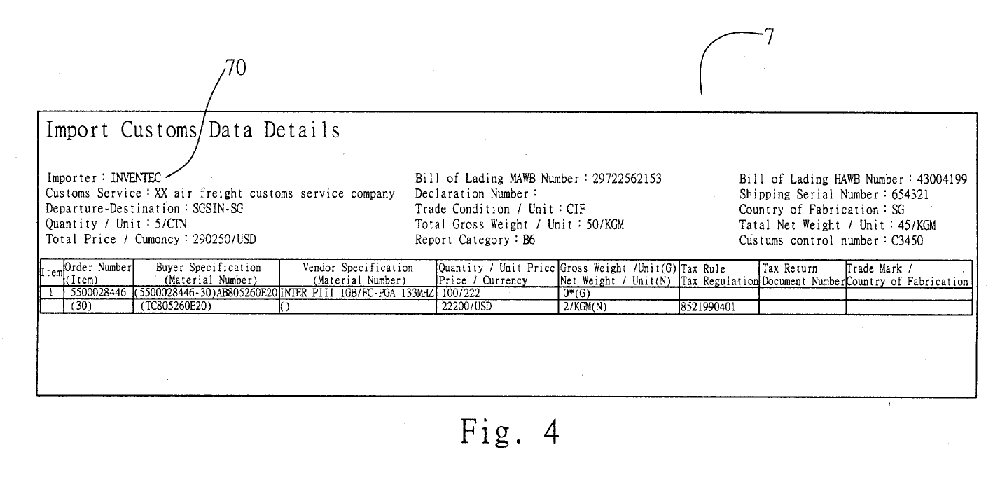

The notification message database 12 receives and stores the detail report sent from the data processing workstation 4. The detail report provides the name or the unified serial number of the receiving organization. As shown in FIG. 4, the data field 70 of the detail report 7 indicates that the name of the contact organization on the detail report is “INVENTEC”. As shown in the figure, in addition to the import customs data details, the detail report 7 also includes other details, for example, the product shipping bill, the export customs data details, receipt details (all not shown), depending on each particular embodiment.

The notification message processing module 13 reads the name or the unified serial number of the receiving organization in the detail report stored in the notification message processing database 12, and retrieves the e-mail address corresponding to the name or the unified serial number of the receiving organization. Base on the retrieved e-mail address, the notification message processing module 13 may then automatically send the detail report stored in the notification message database 12 to the computer device 2 of the receiving organization.

Therefore, after the completion of editing the detail report, it may automatically be sent to the receiving organization through the present invention of an information notification system 1 without wasting any human resource and time.

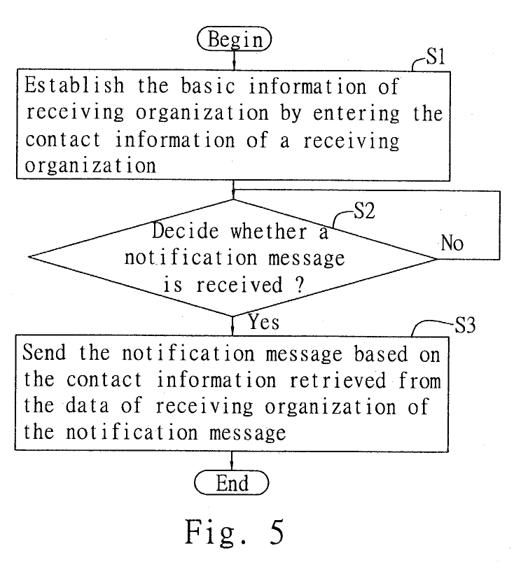

In FIG. 5, the flow steps for performing the present invention of an information notification method are illustrated. First, in step S1, the procedure for establishing the basic information and the contact information of the receiving organization is performed, wherein, after the data manager logged into the present invention of information notification system 1 via the network system 3, the contact information configuration module 11 provides a data entry form (not shown) for entering the basic information of a contact organization, so that the data manager may enter the basic information of the contact organization. On the other hand, the contact information configuration module 11 also provides the data manager with a contact information configuration form (as shown in FIG. 2) for entering the contact information (e.g. e-mail address, fax number, or phone number) of the contact organization. Next, the contact information configuration module 11 stores the basic information of the contact organization and the corresponding contact information into the fundamental database 10, then proceed to step S2.

In step S2, the information notification system 1 decides whether the notification message database 12 has received a request for storing a detail report. If not, then return back to the step S2. Otherwise, proceed to step 3.

In step S3, based on the name and the serial number of the receiving organization retrieved from the detail report that is requested to store, the notification message processing module 13 finds the corresponding e-mail address from the fundamental database 10. And, based on the e-mail address found, the detail report is automatically sent to the e-mail server of the receiving organization through the network system 3.

The invention has been described using exemplary preferred embodiments. However, it is to be understood that the scope of the invention is not limited to the disclosed embodiments. On the contrary, it is intended to cover various modifications and similar arrangements. For example, besides the e-mail address shown in FIG. 2 and FIG. 3, the contact information may also be a facsimile phone number; and besides the detail import report data, the information notification method and system according to the invention can also be applied in sending an error notification report depending on practical requirements. The scope of the claims, therefore, should be accorded the broadest interpretation so as to encompass all such modifications and similar arrangements.

What is claimed is:

1. An information notification method for allowing a receiving unit at an information reception device to be connected with an information notification system via a network system and to receive notification messages, with a database being established in the information notification system for storing basic information of the receiving unit, each record of the basic information corresponding to at least one item of contact information, the information notification method comprising the steps of:
having the information notification system determine if a notification message is received; if no, continuing this determining process; if yes, reading the notification message to obtain relevant data to the receiving unit;
having the information notification system find corresponding contact information from the database according to the obtained relevant data to the receiving unit; and
having the information notification system send the notification message to the information reception device according to the found contact information.

2. The method of claim 1, wherein the basic information of the receiving unit comprises a name and a company registered number of the receiving unit.

3. The method of claim 2, wherein the notification message comprises an import detail report, an export detail report, or an invoice detail report.

4. The method of claim 3, wherein the receiving unit comprises a product order company, an importer, an exporter, or a Customs service company.

5. The method of claim 2, wherein the relevant data to the receiving unit in the notification message comprise a name or a company registered number of the receiving unit.

6. The method of claim 1, wherein the contact information corresponding to the receiving unit comprises an e-mail (electronic mail) address or a facsimile phone number.

7. The method of claim 1, wherein the information reception device comprises a computer device capable of receiving e-mails, or a telephone for receiving facsimile.

8. An information notification system for allowing a receiving unit at an information reception device to receive notification messages via a network system, the information notification system comprising:
a fundamental database for storing basic information of the receiving unit;
a contact information configuration module for providing a contact information input form to which contact information of the receiving unit is entered, and for reading the basic information of the receiving unit from the fundamental database and adding the entered contact information to the basic information of the receiving unit;
a notification message database for storing notification messages sent to the information notification system; and
a notification message processing module for obtaining data of the receiving unit from a notification message stored in the notification message database and for reading contact information from the fundamental database corresponding to the obtained data of the receiving unit, so as to send the notification message stored in the notification message database to the information reception device via the network system according to the contact information of the receiving unit.

9. The system of claim 8, the basic information of the receiving unit comprises a name and a company registered number of the receiving unit.

10. The system of claim 9, wherein the notification message comprises an import detail report, an export detail report, or an invoice detail report.

11. The system of claim 10, wherein the receiving unit comprises a product order company, an importer, an exporter, or a Customs service company.

12. The system of claim 9, wherein the relevant data to the receiving unit in the notification message comprise a name or a company registered number of the receiving unit.

13. The system of claim 8, wherein the contact information corresponding to the receiving unit comprises an e-mail (electronic mail) address or a facsimile phone number.

14. The system of claim 8, wherein the information reception device comprises a computer device capable of receiving e-mails, or a telephone for receiving facsimile.
